(19) United States
(12) Patent Application Publication
(10) Pub. No.: US 2005/0072355 A1
(43) Pub. Date: Apr. 7, 2005

(54) Multiple applicator

(76) Inventor: Robert Petit, Savigny Sur Orge (FR)

Correspondence Address: YOUNG & THOMPSON, 745 SOUTH 23RD STREET, 2ND FLOOR, ARLINGTON, VA, 22202, US

(21) Appl. No.: 10/947,339

(22) Filed: Sep. 23, 2004

(30) Foreign Application Priority Data
Oct. 2, 2003 (FR) 03 11547

(51) Int. Cl. B05C 1/00; B05C 3/02

(52) U.S. Cl. 118/255; 118/200; 132/320

(57) ABSTRACT

The multiple applicator (1) includes a support (2) and a plurality of N specific cosmetic products applicators Aᵢ (3), typically makeup applicators, solidarised to the said support. In this applicator (1):
a) the said support (2) has a two-dimensional configuration comprising a central part (23) and a peripheral part (24) delimited by a border (20), each of the said N applicators being fixed to the said peripheral part (24),
b) the said N specific applicators (3) are longitudinal applicators spaced along the said border (20), such that the said support (2) can be gripped manually between the fingers,
c) the said support (2) has a maximum thickness E typically varying from 5 to 20 mm, so that it can typically be placed in a case. Advantageously these applicators, intended to be housed in a powder case, offer a wide variety of application possibilities in a very compact form, and advantageously replace the conventional powder puff.

### DOMAIN OF THE INVENTION

The invention relates to the domain of packagings for cosmetic products, typically cases for powder cosmetic products, and more particularly means of applying these products to the skin or face.

### STATE OF THE ART

Powder dispensing cases intended for makeup normally use a fibrous part as application means capable of transferring the said powder from the case to the face, usually referred to under the term of “powder puff”.

For example, one such application means is shown in FIG. 1 and is marked as reference “11” in French patent No. 2 819 159, and also in dashed lines in FIGS. 1 and 2 in French patent No. 2 787 687, and in FIG. 4 and reference “9” in French patent No. 2 797 156, all these patents being in the name of the applicant.

### PROBLEMS THAT ARISE

Most applicators according to the state of the art are powder puffs, and there are several types of problems with them.

Firstly, applicators according to the state of the art make the user's fingers dirty.

Secondly, a large part of the powder puff is used for manual gripping rather than application of the said powder.

Finally, since powder puffs form part of the packaging of powders in cases, redesign of packages that is necessary particularly to promote sales in the packaging of cosmetic products also applies to powder puffs that firstly form the most visible part of the case once it has been opened, and secondly the part actually manipulated by the user.

Moreover, once the said powder puff has been used, it quickly becomes a more or less shapeless object and more or less polluted by the said powder, the aesthetics of the open case is adversely affected.

The use of brushes to apply a cosmetic powder to the face is also known, and these brushes are independent applicators kept on a bathroom countertop.

In the case of a brush or powder puff, the applicator is typically formed from a material with a homogenous mass, and can only be used to apply a single powder and to obtain a single type of powder application to the face.

But firstly, it is desirable to obtain variable visual effects using the same powder, and also to have an increasing number of powder cases containing different types of powders.

The invention is aimed at solving these problems. In all cases, the objective is to have a fairly compact applicator so that it will fit in a closed case, and that is fairly easy to manipulate so that it can be used for the finest applications.

### DESCRIPTION OF THE INVENTION

The multiple applicator includes a support and a plurality of N specific cosmetic products applicators Aᵢ, typically makeup applicators, solidarised to the said support, and in this applicator:
a) the said support has a two-dimensional configuration with an upper surface and a lower surface and a median plane P perpendicular to an axial direction of the said applicator, the said support comprising a central part and a peripheral part delimited by a border, each of the said N applicators being fixed by a solidarisation means to the said peripheral part along a so-called radial direction,
b) the said N specific applicators are longitudinal applicators spaced along the said border, such that the said border has at least one free access area for easy manual gripping of the said multiple applicator, so that the said support can be gripped manually between the fingers, typically between the thumb and index finger, the said support thus totally or partly forming manual means of gripping the said multiple applicator,
c) the said support has a maximum thickness E typically varying from 5 to 20 mm, so that it can typically be placed in a case, the size of the said multiple applicator being chosen so that it can be inscribed in a circle with a diameter typically varying from 30 mm to 60 mm, or in a rectangle with a width typically varying from 30 mm to 60 mm, and a length typically varying from 40 mm to 100 mm.

The multiple applicator according to the invention that has the combination of means a) to c) above solves the problems that arise. It provides a means of offering the user a large number N of specific applicators Aᵢ, where i varies from at least 2 to N, that are easy to manipulate and that do not dirty the hands, the multiple applicator being small and adapted to the dimensions of the powder case.

Typically the N specific applicators Aᵢ are oriented along the said radial directions usually perpendicular to the said axial direction.

### DESCRIPTION OF FIGURES

All figures relate to multiple applicators (1) or parts of multiple applicators (1) according to the invention.

FIG. 1a shows a top view of a multiple applicator (1) comprising 3 specific applicators (3) A₁, A₂ and A₃, in which the angle between them is 120° (360°/N).

FIG. 1b is a sectional view of the support (2) along the vertical plane A-A in FIG. 1a.

FIGS. 1c to 1e are enlarged views of the central part (23) of the support (2).

FIG. 1c represents the curved and thinned central part (23) in FIG. 1b.

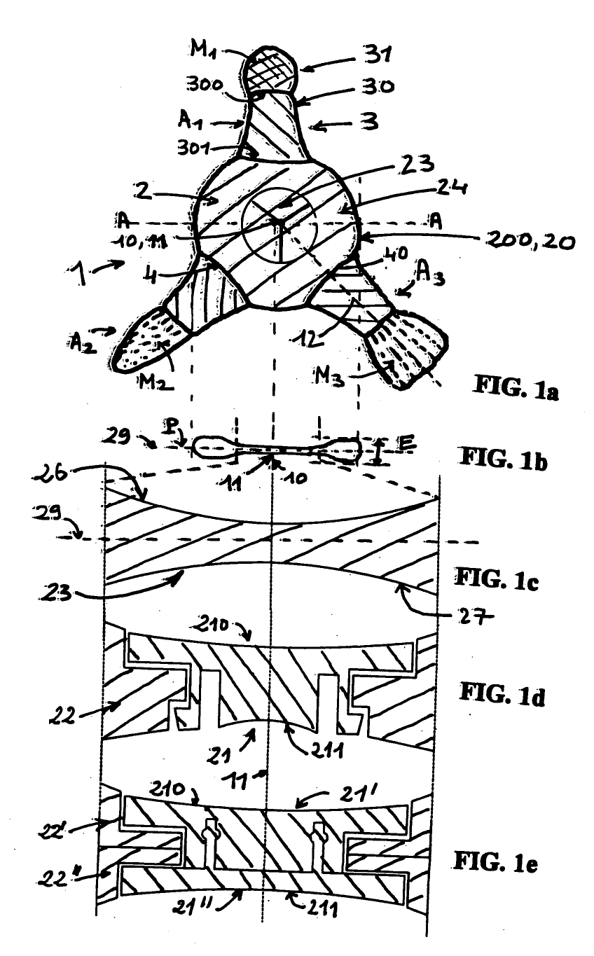

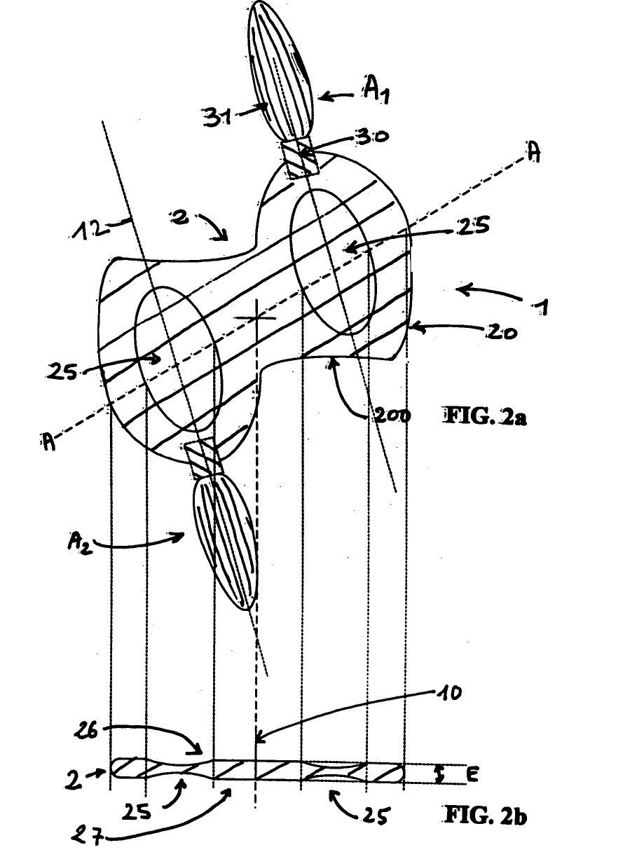

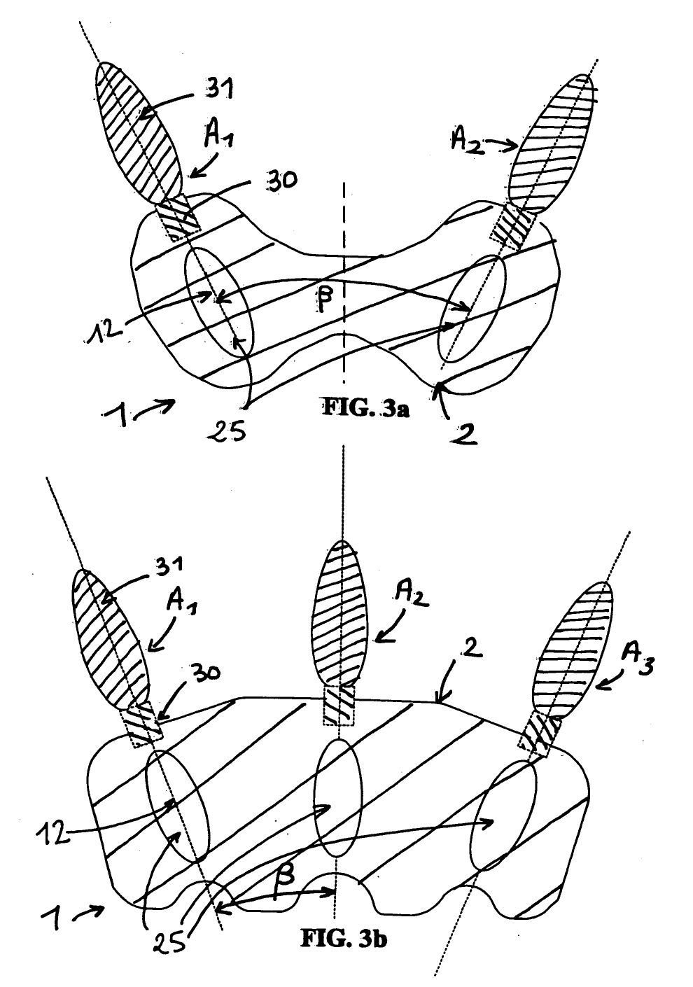

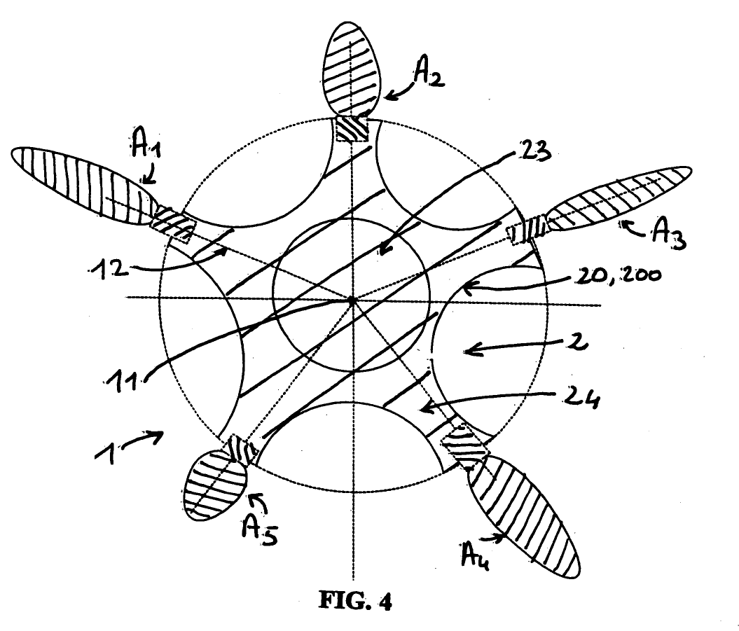

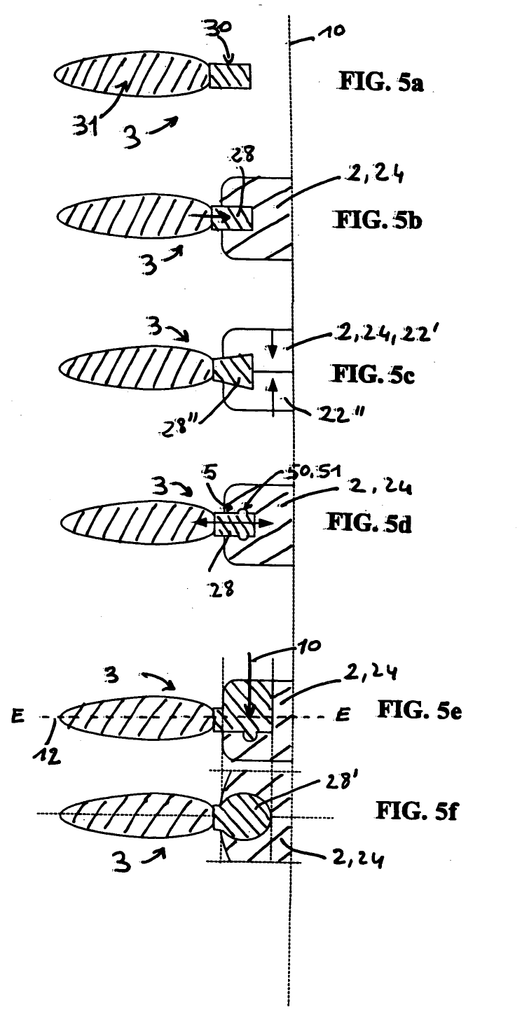

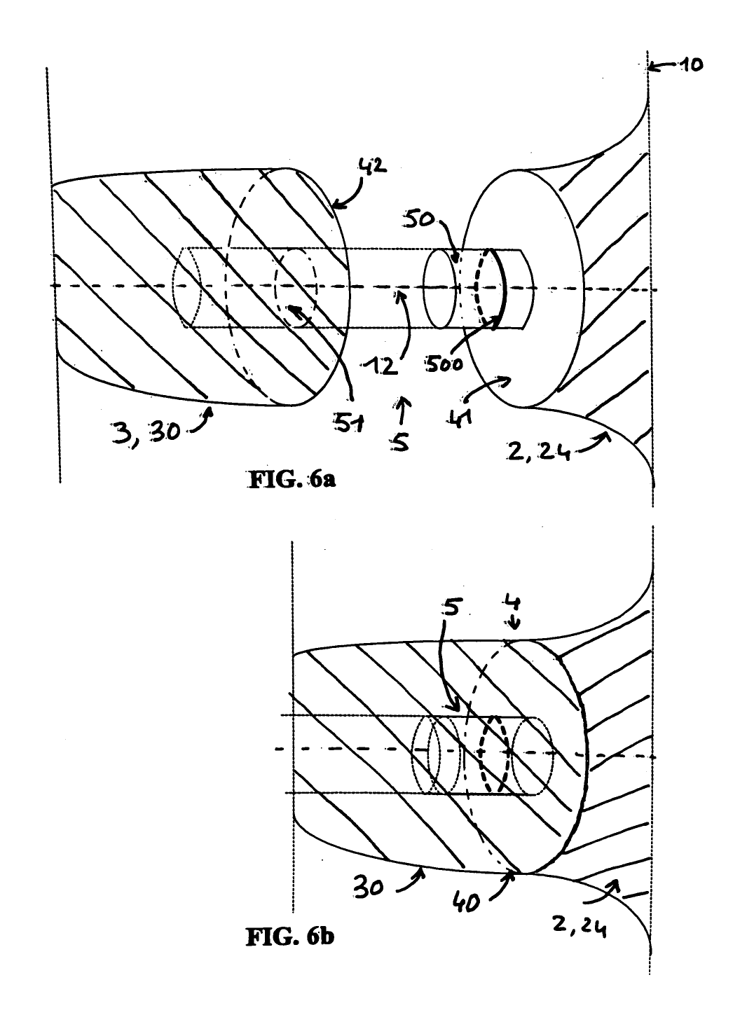

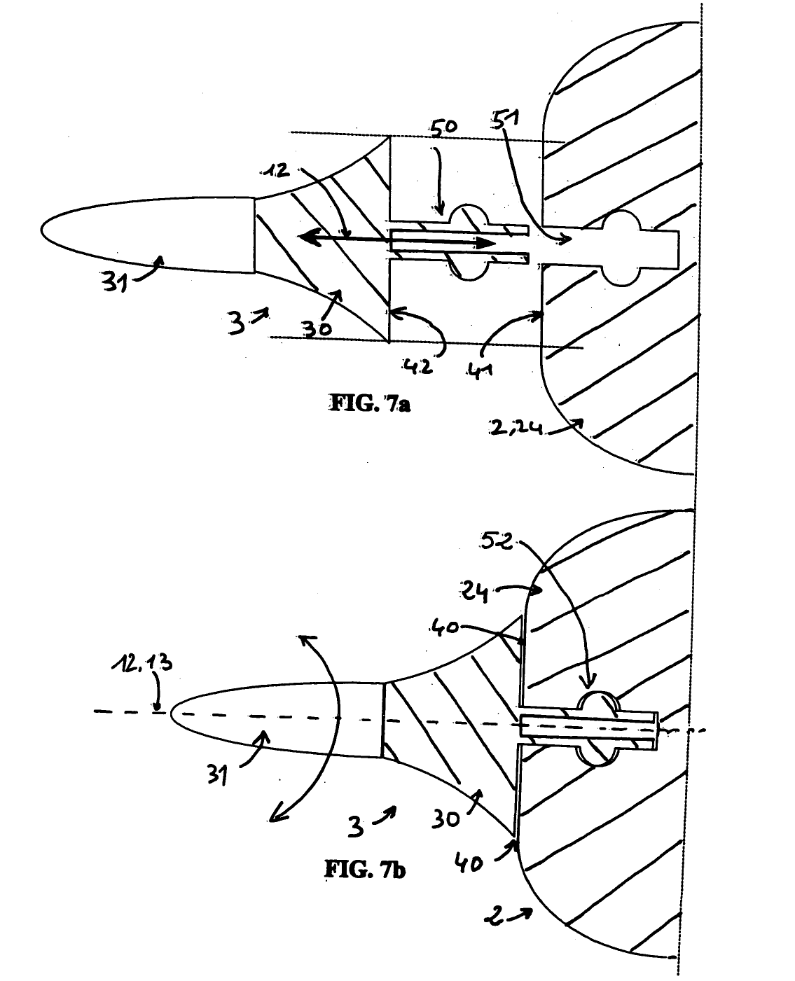

In FIGS. 1d and 1e, the said central part (23) comprises a central part (21, 21′) free to move in rotation about an axis of rotation (11) parallel to the said axial direction (10), with respect to a peripheral part (22, 22′), a central part that comprises a continuous part or upper surface (210) and a discontinuous lower part or lower surface (211). In FIG. 1d, the central part (21) is click fitted into the annular peripheral part (22).

In FIG. 1e, the said peripheral part comprises two superposed peripheral parts, an upper part (22′) and a lower part (22″) that are kept assembled by the said central part (21), itself composed of two central parts, one upper part (21) and one lower part (21″), superposed and click fitted one into the other.

FIG. 2a is a top view of a multiple applicator (1) comprising 2 specific applicators (3) A₁, A₂ offset laterally with respect to each other.

FIG. 2b is similar to FIG. 1b and is a sectional view of the support (2) along the vertical plane A-A in FIG. 2a.

FIGS. 3a and 3b are similar to FIG. 2a and illustrate variants of the multiple applicator (1), where N=2 for FIG. 3a and N=3 for FIG. 3b.

FIG. 4 is similar to FIG. 1a and illustrates the case of a multiple applicator comprising 5 specific applicators (3) A₁, A₂, A₃, A₄ and A₅ in which the angle between them is 72° (360°/5).

FIGS. 5a to 5f illustrate in particular several methods of cooperation or attachment of the specific applicators (3) with the said support (2).

FIGS. 5a to 5e correspond to axial sections in a plane parallel to the said axial direction (10).

FIG. 5a shows a specific applicator (3) comprising a stand (30) and an application material Mᵢ (31).

In FIG. 5b, the said cooperation or attachment is formed by force fitting the stand (30) into a radial peripheral cavity (28) formed in the said peripheral part (24).

In FIG. 5c, similar to FIG. 5a, the said peripheral part comprises two superposed parts (22′) and (22″) assembled as shown in FIG. 1e, forming a typically tapered radial cavity (28″) so as to tighten the said stand (30).

In FIG. 5d, the said cooperation or attachment is formed by a reversible click fitting of the said stand (30) in the said radial peripheral cavity (28).

FIGS. 5e and 5f illustrate an axial embodiment of fastening the stand (30) into an axial peripheral cavity (28′) of the said peripheral part (24).

FIG. 5f is a radial sectional view in plane E-E of FIG. 5e perpendicular to the said axial direction (10).

FIGS. 6a, 6b, 7a and 7b represent embodiments of the said cooperation with a connection of the surfaces of the said stand (30) to the said support (2), typically with no sudden slope change.

FIGS. 6a and 6b are partial sectional views of the said click fitting means (5) of solidarising the stand (30) comprising a male element (30) with elastic separation as a means of solidarisation to a female element (51) formed by the radial peripheral cavity (28) of the support (2).

FIG. 6a shows the stand (30) of the applicator (3) facing the cavity (28), while FIG. 6b shows the stand (30) click fitted into the cavity (28).

FIGS. 7a and 7b show side perspective views illustrating a variant solidarisation means (5), the said support (2) supporting a male element (50) cooperating with a female element (51) of the stand (30).

FIG. 7a shows a view before force fitting, and FIG. 7b shows a view after force fitting, the male element (50) carrying a circular rib (500) designed to facilitate solidarisation of the male element (50) and female element (51).

### DETAILED DESCRIPTION OF THE INVENTION

According to the invention, the said specific applicators Aᵢ (3) may form an angle α>0 between each other and/or they may be laterally offset with respect to an axial direction (10) of the said applicator (1) so that the said multiple applicator (1) can be manipulated so that one A_{N}=i of the N specific applicators (3) can be used without being hindered by the adjacent A_{N}≠i applicators.

The multiple applicator (1) can be gripped manually in different ways depending on which specific applicator Aᵢ is chosen.

According to one embodiment of the invention illustrated for example in FIG. 1a, the said specific applicators Aᵢ (3) may comprise a support stand (30) at its end (300) furthest from the said support, made of a specific application material Mᵢ (31), typically several bristles so as to form a brush, the said stand (30) being fixed to the said support (2) through its so-called near end (301).

According to the invention, the said specific applicators Aᵢ (3) may be irreversibly fixed to the said support (2).

However, as illustrated for example in FIGS. 5d, 7a and 7b, the said specific applicators Aᵢ (3) may be reversibly fixed to the said support (2), the said specific applicators Aᵢ (3) can then possibly be separated from the said support so that they can be used or replaced by other specific applicators.

Moreover, a part of the said specific applicators Aᵢ (3) may be fixed reversibly to the said support (2), the other part being fixed irreversibly to the said support (2).

According to one embodiment of the invention illustrated in FIGS. 1a and 4, the said specific applicators Aᵢ (3) may form an angle α>0 between themselves, such that α is typically equal to 360°/N where N varies typically from 3 to 6. These angles α are typically in the said median plane P perpendicular to an axial direction (11) of the said applicator (1).

There is no need for the specific applicators Aᵢ (3) to make the same angle between each other equal to 360°/N. Depending on the size of the said specific applicators Aᵢ (3), or for aesthetic reasons, it may be advantageous if the angles between the specific applicators (3) are slightly different.

In this embodiment, and as illustrated for example in FIGS. 1d and 1e, the said support (2) may comprise a central part (21, 21′, 21″) typically free to move in rotation, forming the said manual gripping means, and a peripheral part (22, 22′, 22″) forming the support for the said specific applicators Aᵢ (3) so that the said peripheral part (22, 22′, 22″) can be rotated while keeping the central part (21, 21′, 21″) fixed between the fingers.

According to another embodiment of the invention, and as illustrated in FIGS. 2a, 3a and 3b, the said specific applicators Aᵢ (3) may be offset laterally, the said specific applicators Aᵢ (3) possibly having an angular offset β between them, the number N of applicators varying from 2 to 6.

As illustrated in FIGS. 1b to 1e, 2a and 2b, 3a and 3b, the said support (2), or the said central part (21, 21′, 21″) may include or form at least one hollow part (23) or one or several cavities (25) representing the ends of the fingers, so as to facilitate manual gripping of the said support (2) and indicate the position of the fingers. As illustrated in FIGS. 2a, 3a and 3b, the said support (2) may include the said cavity (25) facing each specific applicator Aᵢ (3).

It may be advantageous for each specific applicator Aᵢ (3) to include a fast identification means, the said fast identification means possibly being formed by the colour of the said stand (30), typically made from a plastic material, or by an information or a symbol marked on the said central part (23) or the said peripheral part (24) facing each of the said specific applicators Aᵢ (3).

It is possible that the application materials Mᵢ are visually relatively close, while in reality they are intended for distinct purposes.

If necessary, it may be advantageous to symbolically associate each application material Mᵢ with a specific cosmetic product.

According to the invention, the said specific application materials Mᵢ (31) of the said specific applicators Aᵢ (3) may be chosen from among different types of brushes composed of bristles that differ in their length, diameter or nature, among cellular, alveolar or fibrous materials suitable for applying the said cosmetic product.

As illustrated in FIGS. 6a and 6b, the said stand (30) of the said specific applicator Aᵢ (3) and the said support (2) may be connected through junction surfaces (41) and (42) and according to a typically plane junction line (40) parallel to the said axial direction (10).

As illustrated in FIGS. 6a to 7b, the said solidarisation means (5) may typically comprise a radial or axial cooperation means, with cooperation between a male element (50) forming an axle end and a female element (51) forming a blind hole or hub, the said cooperation also including a means (52) of making the said cooperation reversible or irreversible, by click fitting, force fitting or assembly.

In FIGS. 6a and 6b, the said male element (50) forms part of the said support (2), while the said female element (51) forms part of the said stand (30). The inverse is represented in FIGS. 7a to 7b, in which the said male element (50) forms part of the said stand (30), while the said female element (51) forms part of the said support (2).

As illustrated in FIG. 7b, the said specific applicator (3) may be free to move in rotation about the said radial direction (12), the said stand (30) of the said specific applicator (3) being free to move in rotation with respect to the said support (2), the said radial direction (12) forming an axis of rotation (13).

### EXAMPLE EMBODIMENTS

In general, the specific applicators Aᵢ (3) were made separately.

The supports (2) were made from plastic material by moulding, either separately or by insert moulding of all or part of the stands (30) of the specific applicators (3).

In the case of supports (2) according to FIGS. 1d and 1e, the different support parts (2) were made separately, and they were then possibly assembled before solidarising the said specific applicators Aᵢ (3) to the support (2).

The specific applicators (3) were assembled to the support (2) in different ways:
by insert moulding as mentioned above,
by force fitting,
by welding or gluing,
or by cooperation between mechanical means, typically by click fitting of male and female parts.

FIGS. 1a to 7b form example embodiments of multiple applicators (1). The applicator (1) according to FIG. 1a includes three specific applicators (3) A₁, A₂ and A₃, arranged radially and oriented at 120° from each other, with a support (2) including a curved central part (23) so as to facilitate manual gripping between two phalanxes for each of the three specific applicators (3).

This central curved part forms a rotating click fitting central part (21) as illustrated in FIG. 1d, the upper surface (210) being continuous and the lower surface (211) being discontinuous.

This curved central part includes two parts (21′) and (21″) that can be click fitted, so that the two surfaces (210) and (211) are continuous.

The applicator (1) according to FIGS. 2a and 2b includes two specific applicators (3) A₁ and A₂, oriented at 180° from each other and offset laterally, with a recess (25) being formed in the said support (2) facing each specific applicator (3).

The applicator (1) according to FIG. 3a includes two specific applicators A₁ and A₂ in which the angle β between them is equal to about 60°, the vertex of the angle β being outside the support (2).

The applicator (1) according to FIG. 3b includes three specific applicators (3) A₁, A₂ and A₃ in which the angle β between them is equal to about 35°, the vertex of the angle β being outside the support (2).

The applicator (1) according to FIG. 4 comprises six specific applicators (3) A₁, A₂, A₃, A₄, A₅ and A₆ arranged radially and oriented at about 60° from each other.

The specific applicators (3) shown diagrammatically in FIG. 5a are solidarised to the said support (2) in different ways, as shown in FIGS. 5b to 7b:
FIG. 5b: the specific applicator (3) is fixed to the support by force fitting of the stand (30) into a radial peripheral cavity (28) formed in the said peripheral part (24) of the support (2);
FIG. 5c: the specific applicator (3) is fixed to the support (2) by assembly, the peripheral part (24) of the support or the complete support (2) comprises two superposed parts (22′) and (22″) assembled as indicated in FIG. 1e, forming a typically tapered radial cavity (28″) so as to tighten the said stand (30);
FIG. 5d: the specific applicator (3) is fixed to the support (2) by reversible radial click fitting of the said stand (30) into the said radial peripheral cavity (28), the solidarisation means (5) including cooperation of a circular rib (50) supported by the said stand (30) and a groove (51) supported by the radial peripheral cavity (28) formed in the peripheral part (24) of the support (2);
FIGS. 5e and 5f: the applicator (3) is fixed to the support (2) by axial click fitting of the said stand (30) into the said axial peripheral cavity (28′) formed in the peripheral part (24) of the support (2);
FIGS. 6a and 6b: the applicator (3) and the support (2) are assembled by cooperation of a male element (50) of the support (2) with a female element (51) of the stand (30) of the specific applicator (3), so as to form a continuous junction (4) with continuity of the external surface, in other words without a sudden slope change;
FIGS. 7a and 7b: in this case, the applicator (3) and the support (2) are assembled by cooperation between the male element (50) of the stand (30) of the specific applicator (3), and a female element (51) of the support (2), according to a reversible radial click fitting.
   Advantages of the Invention

The invention has many advantages.

Firstly, multiple applicators (1) according to the invention are easy to manipulate and to a large extent avoid getting the fingers dirty. They may be placed in any powder case and therefore offer the user many functions in a very compact form.

Furthermore, these multiple applicators (1) offer many possibilities for adaptation and change, so that the series of N applicators best adapted to the cosmetic product can be added to any type of cosmetic product, typically a cosmetic powder, particularly to obtain the main effects required when applying powder to the face.

Furthermore, these multiple applicators (1) adapted to powder cases, may contribute to improving the case itself, to the extent that these multiple applicators (1) form objects with a very wide variety of technical functions, which are quite different from a traditional powder puff.

Finally, in a field in which it is important to renew marketed products and be differentiated from other products, these multiple applicators (1) themselves form an important innovation element and a means of customising the case to the extent that they offer an immense variety of possible forms.

List of marks

| | |
|---|---|
| Multiple applicator | 1 |
| Axial direction | 10 |
| Axis of rotation parallel to 10 | 11 |
| Radial direction perpendicular to 10, 11 | 12 |
| Axis of rotation perpendicular to 10 | 13 |
| Support | 2 |
| Edge B | 20 |
| Free access area | 200 |
| Central part | 21, 21′, 21″ |
| Upper part | 210 |
| Lower part | 211 |
| Peripheral part of 21, 21′, 21″ | 22, 22′, 22″ |
| Central curved or hollow part | 23 |
| Peripheral part | 24 |
| Finger recess | 25 |
| Upper surface | 26 |
| Lower surface | 27 |
| Radial peripheral cavity for 30 | 28 |
| Axial peripheral cavity for 30 | 28′ |
| Tapered cavity | 28″ |
| Median plane P of 2 | 29 |
| Specific applicator Aᵢ where i = 2, N | 3 |
| Stand | 30 |
| “Far” end | 300 |
| “Near” end | 301 |
| Specific application material Mᵢ | 31 |
| Junction of 2 and 3 | 4 |
| Junction line | 40 |
| Junction surface of 2 | 41 |
| Junction surface of 3 | 42 |
| Solidarisation means for 2 and 3 | 5 |
| Male element | 50 |
| Circular rib | 500 |
| Female element | 51 |
| Click fitting means for 2 and 3 | 52 |

1. Multiple applicator (1) including a support (2) and a plurality of N specific cosmetic products applicators Aᵢ (3), typically makeup applicators, solidarised to the said support in which:
a) the said support (2) has a two-dimensional configuration with an upper surface (26) and a lower surface (27) and a median plane P (29) perpendicular to an axial direction (10) of the said applicator, the said support comprising a central part (23) and a peripheral part (24) delimited by a border (20), each of the said N applicators being fixed by a solidarisation means (5) to the said peripheral part (24) along a so-called radial direction (12),
b) the said N specific applicators (3) are longitudinal applicators spaced along the said border (20), such that the said border (20) has at least one free access area (200) for easy manual gripping of the said multiple applicator (1), so that the said support (2) can be gripped manually between the fingers, typically between the thumb and index finger, the said support (2) thus totally or partly forming manual means of gripping the said multiple applicator (1),
c) the said support (2) has a maximum thickness E typically varying from 5 to 20 mm, so that it can typically be placed in a case, the size of the said multiple applicator (1) being chosen so that it can be inscribed in a circle with a diameter typically varying from 30 mm to 60 mm, or in a rectangle with a width typically varying from 30 mm to 60 mm, and a length typically varying from 40 mm to 100 mm,
d) the said specific applicators Aᵢ (3) comprise a support stand (30) at its end (300) furthest from the said support, made of a specific application material Mᵢ (31), the said stand (30) being fixed to the said support (2) through its so-called near end (301).

2. Applicator according to claim 1 in which the said specific applicators Aᵢ (3) form an angle α>0 between each other and/or are laterally offset with respect to an axial direction (10) of the said applicator (1) so that the said multiple applicator (1) can be manipulated so that one A_{N=i} of the N specific applicators (3) can be used without being hindered by the adjacent A_{N≠i} applicators.

3. Applicator according to claim 1 in which the said specific application material Mᵢ (31) forms or comprises several bristles so as to form a brush.

4. Applicator according to claim 1 in which the said specific applicators Aᵢ (3) are irreversibly fixed to the said support (2).

5. Applicator according to claim 1 in which the said specific applicators Aᵢ (3) are reversibly fixed to the said support (2), the said specific applicators Aᵢ (3) can then possibly be separated from the said support so that they can be used or replaced by other specific applicators.

6. Applicator according to claim 1 in which some of the said specific applicators Aᵢ (3) are fixed reversibly to the said support (2), the others being fixed irreversibly to the said support (2).

7. Applicator according to claim 1 in which the said specific applicators Aᵢ (3) form an angle α>0 between themselves, such that α is typically equal to 360°/N where N varies typically from 3 to 6.

8. Applicator according to claim 7 in which the said support (2) comprises a central part (21, 21′, 21″) typically free to move in rotation, forming the said manual gripping means, and a peripheral part (22, 22′, 22″) forming the support for the said specific applicators Aᵢ (3) so that the said peripheral part (22, 22′, 22″) can be rotated while keeping the central part (21, 21′, 21″) fixed between the fingers.

9. Applicator according to claim 1 in which the said specific applicators Aᵢ (3) are offset laterally, the said specific applicators Aᵢ (3) possibly having an angular offset β between them, the number N of applicators varying from 2 to 6.

10. Applicator according to cliam 1 in which the said support (2), or the said central part (21, 21′, 21″) includes or forms at least one hollow part (23) or one or several cavities (25) representing the ends of the fingers, so as to facilitate manual gripping of the said support (2) and indicate the position of the fingers.

11. Applicator according to claim 10 in which the said support (2) includes the said cavity (25) facing each specific applicator Aᵢ (3).

12. Applicator according to claim 1 in which each specific applicator Aᵢ (3) includes a fast identification means, the said fast identification means possibly being formed by the colour of the said stand (30), typically made from a plastic material, or by an information or a symbol marked on the said central part (23) or the said peripheral part (24) facing each of the said specific applicators Aᵢ (3).

13. Applicator according to claim 1 in which the said specific application materials Mᵢ (31) of the said specific applicators Aᵢ (3) are chosen from among different types of brushes composed of bristles that differ in their length, diameter or nature, among cellular, alveolar or fibrous materials suitable for applying the said cosmetic product.

14. Applicator according to claim 1 in which the said stand (30) of the said specific applicator Aᵢ (3) and the said support (2) are connected through junction surfaces (42) and (43) and according to a typically plane junction line (40) parallel to the said axial direction (10).

15. Applicator according to claim 1 in which the said solidarisation means (5) typically comprise a radial or axial cooperation means, with cooperation between a male element (50) forming an axle end and a female element (51) forming a blind hole or hub, the said cooperation also including a means (52) of making the said cooperation reversible or irreversible, by click fitting, force fitting or assembly.

16. Applicator according to claim 1 in which the said specific applicator (3) is free to move in rotation about the said radial direction (12), the said stand (30) of the said specific applicator (3) being free to move in rotation with respect to the said support (2), the said radial direction (12) forming an axis of rotation (13).

17. Applicator according to claim 2 in which the said specific application material Mᵢ (31) forms or comprises several bristles so as to form a brush.

18. Applicator according to claim 2 in which the said specific applicators Aᵢ (3) are irreversibly fixed to the said support (2).

19. Applicator according to claim 2 in which some of the said specific applicators Aᵢ (3) are fixed reversibly to the said support (2), the others being fixed irreversibly to the said support (2).

20. Applicator according to claim 2 in which the said specific applicators Aᵢ (3) form an angle α>0 between themselves, such that α is typically equal to 360°/N where N varies typically from 3 to 6.
